(19) United States
(12) Patent Application Publication
(10) Pub. No.: US 2024/0231869 A9
(43) Pub. Date: Jul. 11, 2024

(54) CLUSTER MANAGEMENT PLUGIN WITH SUPPORT FOR MULTIPLE CLUSTERS AND CLUSTER MANAGERS

(71) Applicant: Dell Products L.P., Round Rock, TX (US)

(72) Inventors: Shengli LING, Shanghai (CN); Yuan LI, Suzhou (CN); Wei ZHANG, Lexington, MA (US); Zhijing HU, Shanghai (CN)

(73) Assignee: Dell Products L.P., Round Rock, TX (US)

(21) Appl. No.: 18/051,303

(22) Filed: Oct. 31, 2022

(30) Foreign Application Priority Data
Oct. 20, 2022 (CN) 202211291340.5

(51) Int. Cl. G06F 9/455; G06F 9/445; G06F 9/50

(52) U.S. Cl. CPC G06F 9/45558; G06F 9/44526; G06F 9/5072; G06F 2009/4557; G06F 2209/505

(57) ABSTRACT

Disclosed systems and methods may register a first plugin server as a primary server of a cluster management plugin (CMP) for a user interface (UI) of a virtualization platform client and a second plugin server as an auxiliary server of the CMP. The first plugin server may be associated with a first cluster of the virtualization platform and the second plugin server is associated with a second cluster of the visualization platform. The clusters may include one or more multi-node hyperconverged infrastructure (HCI) clusters. The first cluster may be managed by a first instance of a cluster manager while the second cluster may be managed by a second instance of the cluster manager. A CMP manifest, indicative of user interface extension points defined by the CMP, is loaded into a browser from the primary server. Responsive to detecting an access to one of the extension points while the second cluster is the in-context cluster of the UI, static resources for the extension point are loaded from the auxiliary server and REST API's are called from the auxiliary server.

### TECHNICAL FIELD

The present disclosure relates to the management of information handling systems and, more particularly, customized management features implemented via platform plugins.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Platforms and services for deploying and managing virtualized information handling systems are often configured as web-based resources accessible to IT administrators and other users via standard Web browsers. For example, a virtualization platform may provide browser-ready user interfaces (UIs) that enable users to deploy, configure, and manage virtualized information handling systems and resources. The vSphere virtualization platform from VMware, as an example, includes a vSphere Client UI that provides an administrative interface for creating and managing VMware hosts, i.e., servers provisioned with a hypervisor such as VMWare ESXi for running virtual machines (VMs). To encourage and support for 3^{rd} development of additional features, a platform provider may support the use of plugins. The vSphere Client UI example, as an example, includes built-in support for remote plugins to enable 3^{rd} party developers to extend the infrastructure management capabilities of the platform. However, in at least some instances, plugin support may be conditioned or constrained in one or more ways that conflict with a deployment characteristic of one or more features provided by the plugin. An example of a plugin condition or constraint is a constraint the limits the number of remote plugin instances that can be registered within a platform instance and/or a related or alternative constraint requiring strict equivalence of functionality among two or more instances of a particular plugin. Because such restrictions may, in at least some instances, conflict with likely and/or desirable deployment scenarios, IT administrators may wish to avoid or alleviate the impact of plugin restrictions.

### SUMMARY

In accordance with teachings disclosed herein, common problems associated with limitations placed on the use of platform plugins for a user interface of a virtualization platform client such as, a vSphere client from VMware, are addressed by systems and methods that include registering a first plugin server as a primary server of a cluster management plugin (CMP) for a user interface (UI) of a virtualization platform client and a second plugin server as an auxiliary server of the CMP.

In at least some embodiments, the first plugin server is associated with a first cluster of the virtualization platform and the second plugin server is associated with a second cluster of the visualization platform. In at least some embodiments, the clusters may include one or more multi-node hyperconverged infrastructure (HCI) clusters. In such embodiments, each node may be implemented with an HCI application such as any of the VxRail line of HCI appliances from Dell Technologies.

The first cluster may be managed by a first instance of a cluster manager while the second cluster may be managed by a second instance of the cluster manager. A CMP manifest, indicative of user interface extension points defined by the CMP, is loaded into a browser from the primary server. Responsive to detecting an access to one of the extension points while the second cluster is the in-context cluster of the UI, static resources for the extension point are loaded from the auxiliary server and REST API's are called from the auxiliary server of the in-context cluster. On the other hand, responsive to detecting an access to one of the extension points while the first cluster is the in-context cluster of the virtualization platform user interface, static resources for the extension point are loaded from the auxiliary server and REST API's are called from the auxiliary server for the in-context cluster.

In at least some embodiments, disclosed methods further include responding to detecting an access to one of the extension points by loading plugin code from the primary server and sending a server ID lookup request to a plugin core in the primary. In addition, disclosed systems and methods may further include determining, based on one or more cluster custom attributes of the in-context cluster, a server ID for the in-context cluster and a universal resource locator (URL). The cluster custom attributes may include the IP address of the applicable plugin server and a version indicator for the applicable cluster manager.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an exemplary topology for a virtualization platform in accordance with disclosed teachings;

FIG. 2 illustrates an exemplary plugin in accordance with disclosed teachings;

FIG. 3 illustrates UI and API traffic within a virtualized platform in accordance with disclosed teachings;

FIG. 4 illustrates a flow diagram of a plugin method for use in conjunction with a virtualization platform client; and

FIG. 5 illustrates an exemplary information handling system suitable for use conjunction with the systems and method illustrated in FIG. 1 through FIG. 4.

### DETAILED DESCRIPTION

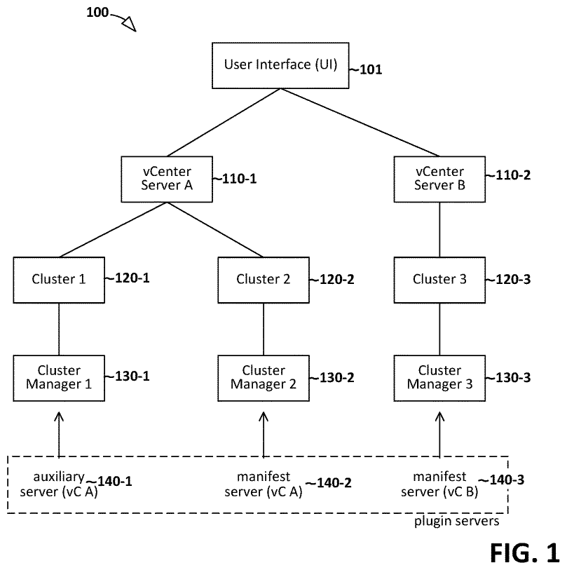

Exemplary embodiments and their advantages are best understood by reference to FIGS. 1-5, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates an exemplary topology for a virtualization platform 100. As depicted in FIG. 1, the illustrated platform 100 includes a UI 101 for a client of the virtualization platform, which may be implemented with, for example, a vSphere platform from VMware, in which case the UI 101 depicted in FIG. 1 may correspond to a vSphere client UI. The illustrated topology further includes a virtualization platform tier including a pair of virtualization platform instances 110-1, and 110-2, a cluster tier including a group of three clusters 120-1, 120-2, and 120-3, a cluster manager tier including a group of cluster managers 130-1, 130-2, and 130-3, and a plugin server tier including a group of three plugin servers 140-1, 140-2 and 1403.

The illustrated UI 101 spans two instances of vCenter servers including vCenter Server A (110-1) and vCenter Server B (110-2). With respect to vCenter Server B (110-2), FIG. 1 further illustrates a single cluster, Cluster 3 (120-3) running under vCenter Server B (110-2), a single cluster manager 130-3 managing cluster 3, and a manifest server 140-3 providing a plugin server for the applicable plugin tool. As depicted in FIG. 1, the topology for vCenter Server B would comply with any plugin constraint prohibiting more than one registered plugin per vCenter instance.

In contrast, FIG. 1 further illustrates a second vCenter server instance, vCenter Server A (110-1) spanning two clusters 120 including Cluster 1 (120-1) and Cluster 2 (120-2). Cluster 1 (120-1) is illustrated in FIG. 1 managed by a Cluster Manager 1 (130-1) while Cluster 2 (120-2) is managed by a Cluster Manager 2 (130-2).

In at least some conventional plugin deployments, UI 101 may not support more than one registered plugin per virtualization platform instance. Thus, because both clusters 120 are running under vCenter Server A (110-1), IT managers may be constrained from employing cluster-specific functionality within the plugin. Disclosed teachings enable and support the use of cluster-specific plugin functionality and, more generally, the use of multiple instances of a registered plugin per virtualization platform where each plugin instance may have at least some unique functionality. Disclosed features are implemented, at least in part, by leveraging a supported plugin feature to implement instance-specific plugin functionality. Accordingly, FIG. 1 illustrates auxiliary server 140-1 as the plugin server for Cluster Manager 1 (130-1) and manifest server (140-2) as the plugin server for Cluster Manager (130-2). In this manner, disclosed features employ an auxiliary plugin server, which is supported by the platform UI, in conjunction with the primary/manifest plugin server, to achieve plugin instances that may support functions and features that differ in one or more ways. In such embodiments, the plugin server invoked for a plugin request may be determined based on an “in-context” platform resource, i.e., a platform resource that is currently active within the UI 101.

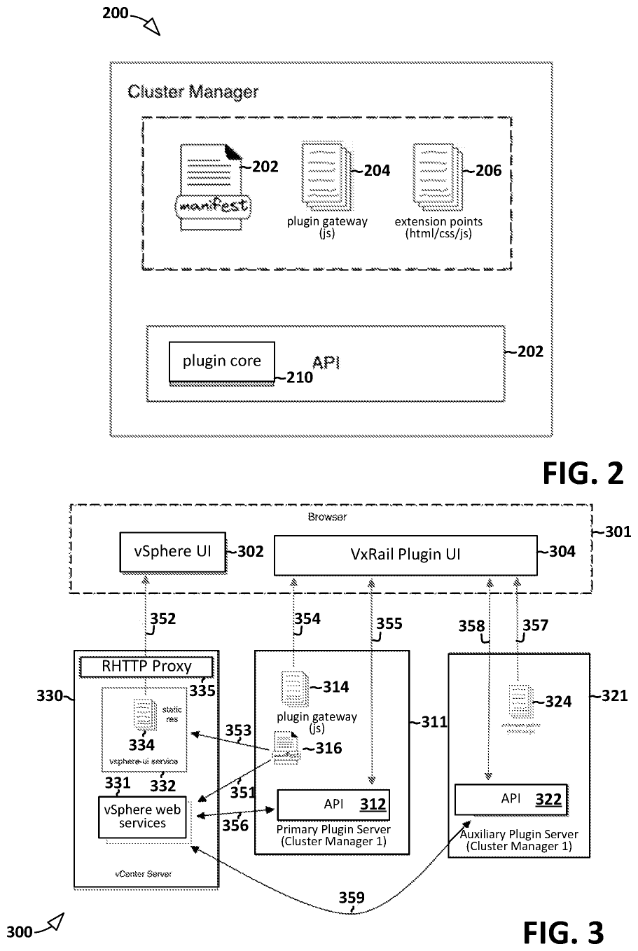

Referring now to FIG. 2, elements of an exemplary plugin server 200 are depicted. The illustrated plugin server 200 is associated with a particular cluster manager and includes a plugin manifest 202, plugin gateway code 204, and an extension points document 206. The illustrated plugin server 200 further includes an API module 208 including a plugin core 210 providing endpoints for server ID lookups. Referring back to the topology depicted in FIG. 1, the elements of plugin server 200 as depicted in FIG. 2 may be common to the auxiliary plugin server 140-1 as well as the manifest or primary plugin server 140-2 and this may be true regardless of whether the element is actually used. For example, as described below, even though the plugin manifest is retrieved from the manifest plugin server only, the auxiliary plugin server may still include a plugin manifest. The elements of plugin server 200 and other aspects of plugin architecture will be familiar to those of ordinary skill in the field. See, e.g., Developing Remote Plug-ins with the vSphere Client Software Development Kit (SDK), Update 2, from VMware, see the https URL: docs.vmware.com.

Referring now to FIG. 3, an exemplary implementation 300 of disclosed teachings is illustrated for a cluster management plugin identified herein as the VxRail plugin. The implementation 300 illustrated in FIG. 3 includes a conventional web browser 301, a primary plugin server 311, an auxiliary plugin server 321, and a vCenter Server 330. The illustrated web browser 301 includes a vSphere Client UI 302 and a VxRail plugin UI 304. The depicted embodiment may be compatible with implementations featuring a multi-node HCI cluster comprising two or more HCI nodes, each of which may be implemented in any of the VxRail line of HCI appliances from Dell Technologies.

Consistent with the plugin server of FIG. 2, the primary plugin server 311 includes a plugin gateway 314, a plugin manifest 316, and a plugin core labeled as API module 312. The auxiliary plugin server 321 depicted in FIG. 3 includes static resources 324, containing extension points for the VxRail PlugIn UI 304, and an API module 322. The illustrated vCenter Server 330 includes vSphere web services 331 and vSphere-UI service 332 including static resources 334 for vSphere UI 302. The illustrated implementation includes an HTTP proxy 335 to communicate between browser 301 and vCenter Server 330 and between browser 301 and the plugin servers 311 and 321.

FIG. 3 illustrates UI and API communication that may occur when the VxRail plugin is invoked. More specifically, FIG. 3 illustrates communications that occur when an extension point is selected in conjunction with the cluster manager served by the auxiliary plugin server 321. This example is illustrated to demonstrate features that depart from the conventional plugin model.

Initially, primary plugin server 311 and auxiliary plugin server 321 are registered (operation 351) with vCenter Server 330 via vSphere web services 331. Static resources 334 for vSphere client UI 302 are loaded (operation 352) into browser 301. The vSphere UI service 332 may then load and parse (operation 353) manifest 316 from primary plugin server 311.

When an extension point is accessed, plugin gateway JS 314 may then be loaded (operation 354) into, for example, a plugin inline frame (iframe) view from primary plugin server 321. The VxRail plugin UI 304 may then send (operation 355) a Server ID lookup request to the plugin core (API module 312) in primary plugin server 311 to determine a Server ID for the in-context cluster, i.e., the cluster that is currently active in the vSphere client. The Server ID for the in-context cluster may be determined (operation 356) from one or more cluster custom attributes including, as illustrative examples, server IP, manager version. The API module 312 may then determine a proxied URL for the auxiliary server based on the server ID and a plugin server list provided by the platform plugin SDK and load (operation 357) static resources 324 for the extension point from the auxiliary plugin server 321. Next, REST API 322 of auxiliary plugin server 321 is called (operation 358) from plugin UI 304 and vSphere web service APIs 331 of vCenter server 330 are called (operation 359) from auxiliary plugin server 321. In at least some embodiments, operations 354, 355, 357, and 358 are all sent to reverse HTTP proxy 335 and forwarded to primary plugin server 311 or auxiliary plugin server 321 according to the proxied URLs.

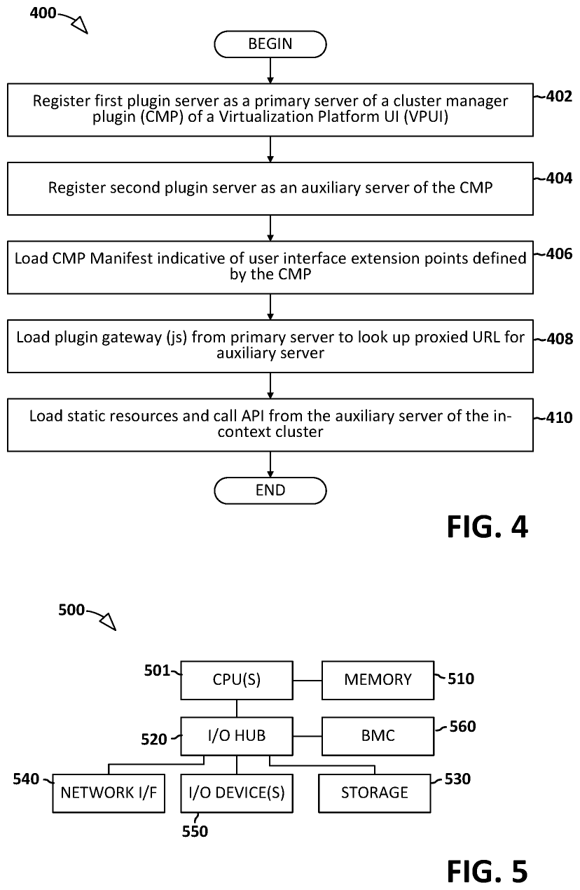

Referring now to FIG. 4 a flow diagram illustrates a method 400 in accordance with disclosed teachings for implementing multiple cluster management platform plugins, associated with multiple cluster managers and their corresponding clusters, within a single instance of the virtualization platform. The illustrated method begins with registering (operation 402) a first plugin server as a primary server of a cluster management plugin (CMP) for a virtualization platform user interface (VPUI), wherein the first plugin server is associated with a first cluster within the virtualization platform. A second plugin server is then registered (operation 404) as an auxiliary server for the CMP, wherein the second plugin server is associated with a second cluster running in the virtualization platform. A CMP manifest indicative of user interface extension points defined by the CMP may be loaded (operation 406) from the primary server. Responsive to detecting an access to one of the extension points while the second cluster is the in-context cluster, a proxied URL of the auxiliary server is determined (operation 408). Static resources may then be loaded from the auxiliary server and APIs of the auxiliary server may be called (operation 410).

Referring now to FIG. 5, any one or more of the elements illustrated in FIG. 1 through FIG. 4 may be implemented as or within an information handling system exemplified by the information handling system 500 illustrated in FIG. 5. The illustrated information handling system includes one or more general purpose processors or central processing units (CPUs) 501 communicatively coupled to a memory resource 510 and to an input/output hub 520 to which various I/O resources and/or components are communicatively coupled. The I/O resources explicitly depicted in FIG. 5 include a network interface 540, commonly referred to as a NIC (network interface card), storage resources 530, and additional I/O devices, components, or resources 550 including as non-limiting examples, keyboards, mice, displays, printers, speakers, microphones, etc. The illustrated information handling system 500 includes a baseboard management controller (BMC) 560 providing, among other features and services, an out-of-band management resource which may be coupled to a management server (not depicted). In at least some embodiments, BMC 560 may manage information handling system 500 even when information handling system 500 is powered off or powered to a standby state. BMC 560 may include a processor, memory, an out-of-band network interface separate from and physically isolated from an in-band network interface of information handling system 500, and/or other embedded information handling resources. In certain embodiments, BMC 560 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
registering a first plugin server as a primary server of a cluster management plugin (CMP) for a virtualization platform user interface (VPUI), wherein the first plugin server is associated with a first cluster within the virtualization platform;
registering a second plugin server as an auxiliary server for the CMP, wherein the second plugin server is associated with a second cluster running in the virtualization platform;
loading a CMP manifest, indicative of user interface extension points defined by the CMP, from the primary server;
responsive to detecting an access to one of the extension points while the second cluster is the in-context cluster of the VPUI:
loading static resources for the extension point from the auxiliary server; and
calling REST API's from the auxiliary server; and
responsive to detecting an access to one of the extension points while the first cluster is the in-context cluster of the VPUI:
loading static resources for the extension point from the primary server; and
calling REST API's from the primary server.

2. The method of claim 1, further comprising:
responsive to detecting an access to one of the extension points:
loading a plugin code from the primary server; and
sending a server ID lookup request to a plugin core in the primary server.

3. The method of claim 2, further comprising:
determining, based on one or more cluster custom attributes of the in-context cluster, a server ID for the in context cluster; and
determining, based on the server ID, a URL for the in-context cluster.

4. The method of claim 3, wherein the cluster custom attributes include a server IP address and a manager version.

5. The method of claim 1, wherein the VPUI comprises a vSphere Client user interface.

6. The method of claim 1, wherein the at least one of the first and second clusters comprise an HCI running in an HCI appliance.

7. An information handling system, comprising:
a central processing unit (CPU); and
a memory including processor executable instructions that, when executed by the CPU, cause the system to perform operations including:
registering a first plugin server as a primary server of a cluster management plugin (CMP) for a virtualization platform user interface (VPUI), wherein the first plugin server is associated with a first cluster within the virtualization platform;
registering a second plugin server as an auxiliary server for the CMP, wherein the second plugin server is associated with a second cluster running in the virtualization platform;
loading a CMP manifest, indicative of user interface extension points defined by the CMP, from the primary server;
responsive to detecting an access to one of the extension points while the second cluster is the in-context cluster of the VPUI:
loading static resources for the extension point from the auxiliary server; and
calling REST API's from the auxiliary server; and
responsive to detecting an access to one of the extension points while the first cluster is the in-context cluster of the VPUI:
loading static resources for the extension point from the primary server; and
calling REST API's from the primary server.

8. The information handling system of claim 1, further comprising:
responsive to detecting an access to one of the extension points:
loading a plugin code from the primary server; and
sending a server ID lookup request to a plugin core in the primary server.

9. The information handling system of claim 2, further comprising:
determining, based on one or more cluster custom attributes of the in-context cluster, a server ID for the in context cluster; and
determining, based on the server ID, a URL for the in-context cluster.

10. The information handling system of claim 3, wherein the cluster custom attributes include a server IP address and a manager version.

11. The information handling system of claim 1, wherein the VPUI comprises a vSphere Client user interface.

12. The information handling system of claim 1, wherein the at least one of the first and second clusters comprise an HCI running in an HCI appliance.
